(19) United States
(12) Patent Application Publication
(10) Pub. No.: US 2023/0265013 A1
(43) Pub. Date: Aug. 24, 2023

(54) Method for the Thermal Treatment of Mineral Raw Materials

(71) Applicant: Lhoist Recherche et Développement S.A., Ottignies-Louvain-la-Neuve (BE)

(72) Inventor: Thomas Perterer, Düsseldorf (DE)

(21) Appl. No.: 18/014,090

(22) PCT Filed: Jul. 2, 2021
(86) PCT No.: PCT/EP2021/068280

§ 371 Date: Dec. 30, 2022

(30) Foreign Application Priority Data
Jul. 2, 2020 (DE) 10 2020 117 478.0

(51) Int. Cl. C04B 2/10; F27D 11/06; F27D 7/04

(52) U.S. Cl. CPC C04B 2/104; F27D 11/06; F27D 7/04; F27M 2003/03; F27D 2007/045

(57) ABSTRACT

A method for the thermal treatment of mineral raw materials such as limestone or dolomite is shown and described, which includes at least the following steps of a. providing a mineral bulk material and a conductive material and b. placing the mineral bulk material and the conductive material into a kiln, generating an electromagnetic field inside the kiln, thermally treating the mineral bulk material in the kiln by means of electromagnetic excitation of the conductive material in the electromagnetic field, and removing the thermally treated mineral bulk material and the conductive material from the kiln. Using the method described, even large quantities of mineral bulk material can be efficiently converted.

### CROSS-REFERENCE TO RELATED APPLICATIONS

This application is the United States national phase of International Application No. PCT/EP2021/068280 filed Jul. 2, 2021, and claims priority to German Patent Application No. 10 2020 117 478.0 filed Jul. 2, 2020, the disclosures of which are hereby incorporated by reference in their entirety.

### BACKGROUND OF THE INVENTION

### Field of the Invention

The present invention relates to a method for the thermal treatment of mineral raw materials, a kiln, the use of an electromagnetically excited conductive material for the thermal treatment of a mineral raw material, burnt lime and/or burnt dolomite, and an apparatus for the thermal treatment of a mineral raw material.

### Description of Related Art

The calcination of carbonate-containing mineral raw materials usually takes place in directly fired shaft kilns or rotary kilns. In the case of direct firing, one or more fuel(s) is/are metered into a combustion unit and burned there with the supply of oxygen. At temperatures of over 800° C., in addition to carbon dioxide from the carbonate-containing mineral raw materials, gaseous oxidation products such as nitrogen oxides (NOX), sulfur oxides (SOX), dioxanes or furans are formed from the fuels. As a result, the carbon dioxide produced during the calcination mixes with the exhaust gas produced by the combustion of fossil, biogenic or so-called secondary fuels.

The resulting exhaust gas stream thus contains, in addition to carbon dioxide, other exhaust gases that have to be laboriously separated by expensive exhaust gas treatment systems. Despite the complex purification of the exhaust gas flow, traces of environmentally harmful nitrogen oxides or sulfur oxides can get into the environment.

### SUMMARY OF THE INVENTION

Consequently, there is a need for methods for calcining carbonate-containing mineral raw materials in which smaller quantities of gaseous oxidation products such as nitrogen oxides or sulfur oxides are formed. It would be particularly advantageous if methods could be developed in which no gaseous products besides carbon dioxide are formed.

Methods for calcining carbonate-containing mineral raw materials must, however, at the same time also meet high requirements in terms of throughput and energy efficiency. For an economical preparation of calcined carbonate-containing mineral raw materials, the material must be calcined quickly, efficiently, and completely. In order to keep costs low and to make the method as ecological as possible, the lowest possible energy consumption is also important.

U.S. Pat. No. 2,015,642 describes a method for calcining calcium carbonate, in which calcium carbonate is passed as a thin stream through an electrically heated, previously evacuated kiln. Electric heating only keeps carbon dioxide in the exhaust gas stream.

However, the method described in U.S. Pat. No. 2,015,642 is not suitable for calcining large quantities of calcium carbonate effectively in a short time. This method is rather unsuitable for large-scale approaches to calcining carbonate-containing mineral raw materials.

JP 2013/180940 A describes a method for calcining limestone, in which the interior of a kiln is electromagnetically warmed by means of externally mounted coils and limestone located in the kiln is heated. Using this method, pure carbon dioxide is obtained as a waste gas stream, but the method is very energy-intensive and difficult to scale. The method described in JP 2013/180940 A cannot effectively calcine large, industrial quantities of limestone.

Consequently, there continues to be a need for methods for calcining carbonate-containing mineral raw materials such as limestone, which only have carbon dioxide as an exhaust gas product and at the same time have high efficiency and low energy consumption.

The object of the present invention is thus to provide a method for calcining carbonate-containing mineral raw materials, in which carbon dioxide is the only exhaust gas product that is formed. The method should be suitable for industrial quantities of raw materials to be calcined and allow for a high throughput of material.

In addition, the object of the invention is to provide a method in which expelled carbon dioxide can be recovered in pure form directly from the method in order to be able to store it or to be able to use it for other applications.

Furthermore, the present invention is intended to provide a method in which the mineral raw material is completely converted in an efficient manner and no or as little as possible over- or under-burning of the material takes place. It is an object of the invention to provide a method with which particularly clean converted material can be obtained.

Another object of the present invention is to provide a method with which large quantities of mineral raw materials, in particular carbonate-containing mineral raw materials, can be converted in a short time. In particular, the method should be suitable for industrial applications.

Another object of the present invention is to provide a method that is resource-saving and energy-efficient. In addition, the method should be as cost-effective as possible.

The present invention has furthermore the object of providing an apparatus which is suitable for such an improved method for the thermal treatment of mineral raw materials. In particular, the object of the invention is to provide an apparatus with which pure carbon dioxide can be obtained directly from a calcining process.

All or some of these objects are achieved according to the invention as described herein, the kiln as described herein, the use as described herein, the product and the apparatus as described herein.

Advantageous embodiments of the invention are specified in the dependent claims and are explained in detail below.

The method according to the invention for the thermal treatment of mineral raw materials comprises at least the steps of:
a. providing a mineral bulk material and a conductive material,
b. placing the mineral bulk material and the conductive material into a kiln,
c. generating an electromagnetic field inside the kiln,
d. thermally treating the mineral bulk material in the kiln by means of electromagnetic excitation of the conductive material in the electromagnetic field,
e. removing the thermally treated mineral bulk material and the conductive material from the kiln.

Surprisingly, it has been shown that even large quantities of mineral bulk material can be efficiently converted using the method according to the invention. Using the method according to the invention, the mineral bulk material can be thermally treated in a particularly clean manner, with particularly few by-products or disruptive impurities arising in the course of the method. The conditions of the thermal treatment can be precisely controlled and adjusted using the method according to the invention, so that an optimal balance can be found between complete conversion of the mineral raw material and an efficient procedure. Furthermore, the method according to the invention is easily scalable and is outstandingly suitable for the industrial scale.

In addition, the method according to the invention is characterized by high energy efficiency. Using the method according to the invention, pure exhaust gases can be obtained which are not contaminated by exhaust gases that are harmful to the environment and/or health, such as nitrogen oxides and/or sulfur oxides.

Without wishing to be bound by a specific scientific theory, the particular advantages of the method according to the invention seem to be attributable to the interaction of the conductive material excited by the electromagnetic field with the mineral bulk material. The conductive material, which is in direct contact with the mineral material, is heated by the electromagnetic field. The mineral bulk material is heated directly and quickly in this way. The heat transfer is more efficient with this procedure than in a method in which an entire kiln has to be heated up by means of electromagnetically-induced heat. In addition, for this reason the method according to the invention is also suitable for the industrial scale. Furthermore, the direct heat transfer means that less energy is required to heat the mineral bulk material.

The sequence of the method steps can vary depending on the subject. The method according to the invention is preferably carried out in the order given. According to a further embodiment of the invention, the electromagnetic field is generated inside the kiln before placing the mineral bulk material and the conductive material into the kiln.

In method step b. of the method according to the invention, the mineral bulk material and the conductive material can each be placed individually into the kiln or previously combined and then placed together into the kiln. The mineral bulk material and the conductive material can preferably be mixed before being placed into the kiln. Due to the homogeneous mixing of mineral bulk material and conductive material, this results in a particularly good heat transfer from the conductive material to the mineral bulk material. Alternatively, the mineral bulk material and the conductive material can also be mixed in the kiln. In this way, the method is designed to be particularly simple and cost-effective. The mixing of mineral bulk material and conductive material in the kiln has also proven to be sufficient in this case for the thermal treatment of the mineral raw material.

It has been shown that the method according to the invention is basically suitable forthe thermal treatment of very different mineral raw materials.

The terms “mineral raw materials” or “mineral bulk material” refer in this case and elsewhere to all types of mineral substances and/or mixtures of substances. The terms “mineral raw material” and “mineral bulk material” include both pure substances and mixtures. For example, the term “mineral bulk material” encompasses both bulk material made of pure calcium carbonate and bulk material made of mixtures of calcium carbonate and other substances. “Mineral bulk material” is bulk material made from “mineral raw materials.”

In the method according to the invention, the mineral bulk material preferably comprises a hydroxide and/or a carbonate. These mineral bulk materials are particularly suitable for the method according to the invention.

The mineral bulk material particularly preferably comprises a carbonate. In the case in which the mineral bulk material comprises a carbonate, pure carbon dioxide, which has no impurities from other exhaust gases, can be removed from the bulk material using the method according to the invention. In addition, mineral bulk material which comprises at least one carbonate can be heated particularly efficiently using the conductive material.

According to a further preferred embodiment of the invention, the mineral bulk material is selected from the group consisting of limestone, dolomite, magnesite, hydrated lime, carbonate ores and mixtures thereof. These bulk materials can be thermally treated in an excellent manner using the method according to the invention.

In this case, the method according to the invention can be set precisely for each of the bulk materials mentioned.

The mineral bulk material is particularly preferably selected from limestone, dolomite, and mixtures thereof. Most preferably, the mineral bulk material is limestone. The method according to the invention is particularly suitable for calcining limestone and/or dolomite. Using the method according to the invention, pure carbon dioxide, which is substantially free of impurities, is removed from limestone and/or dolomite. The calcination proceeds particularly cleanly and the calcination conditions can be set variably using the method according to the invention.

The mineral bulk material used in the method according to the invention preferably has a bulk density of 1.0 to 3.0 t/m3, particularly preferably 1.1 to 2.6 t/m3. Mineral bulk material with this bulk density can easily be guided through the kiln and evenly mixed with the conductive material.

According to a further preferred embodiment of the method according to the invention, the conductive material has a bulk density of 3.0 to 7.0 t/m3, preferably from 3.5 to 6.5 t/m3. If the conductive material has such a bulk density, it is particularly easy to transport and mix with the mineral bulk material.

According to a particularly preferred embodiment of the method according to the invention, the mineral bulk material has a bulk density of 1.0 to 3.0 t/m3, preferably 1.1 to 2.6 t/m3, and at the same time the conductive material has a bulk density of from 3.0 to 7.0 t/m3, preferably from 3.5 to 6.5 t/m3. If the mineral bulk material and the conductive material have such similar bulk densities, there is a particularly good mixing of mineral bulk material and conductive material. As a result, the heat transfer from the conductive material to the mineral bulk material is particularly efficient.

Methods for determining the bulk density are known to the person skilled in the art.

The bulk density of the mineral bulk material used in the method according to the invention and/or the conductive material is preferably determined in accordance with standard DIN EN 1097-3 and/or standard DIN EN ISO 60.

The mean particle size (d50) of the mineral bulk material used in the method according to the invention can vary within wide ranges. A particularly efficient heat transfer from the conductive material to the mineral bulk material is achieved if the mineral bulk material has a mean particle size (d50) of 0.5 to 50 mm, preferably 1.0 to 30 mm. If the mineral bulk material has a larger mean particle size, a complete thermal treatment of the mineral bulk material may require high temperatures and/or longer treatment times. If, on the other hand, the mineral bulk material is smaller than in accordance with the preferred mean particle sizes, dust can form.

The mean particle size (d50) of the conductive material used in the method according to the invention can also vary within wide ranges. It has been found to be particularly advantageous if the conductive material has a mean particle size (d50) of from 1.0 to 70.0 mm, more preferably from 2.0 to 50.0 mm. If the conductive material has such a mean particle size, the conductive material mixes particularly evenly with the mineral bulk material. In addition, the heat losses in the case of conductive material with the preferred mean particle sizes are particularly low.

It is particularly advantageous if both the mineral bulk material and the conductive material have the preferred mean particle size (d50). The mixing and heat transfer of conductive material to the mineral bulk material are particularly advantageous in this case.

Values for the mean particle sizes, in particular d50 values, of particles of a material can be determined, for example, by the particle size distribution of the material. The d50 value is usually understood as the value at which 50 wt. % of the material would pass through the openings of a certain size of a theoretical sieve.

To determine the particle size distribution, various methods are known to those skilled in the art. For example, the particle size distribution can be determined by sieving experiments or sieve analysis. Alternatively, the particle size distribution can be carried out using laser diffractometry. The particle size distribution is preferably determined by means of sieve experiments.

The determination of the particle size distribution by means of sieve analysis can in particular be carried out by means of DIN 66165-1 and DIN 66165-2. DIN 66165-1 defines the basics for sieve analysis and DIN 66165-2 describes the specific implementation of sieve analysis. The sieve analysis can preferably be carried out by dry sieving with a sieve tower which is attached to a sieving machine, preferably as described in DIN 66165-2. In the sieve analysis with sieve tower, a plurality of sieves or analysis sieves are arranged on top of one another and clamped onto the sieve machine. These test sieves or analysis sieves each consist of a sieve bottom and a sieve frame. The mesh sizes of the individual test sieves or analysis sieves are in descending order from top to bottom. When performing the sieve analysis, the sample to be analyzed is placed on the coarsest test or analysis sieve and exposed to a defined movement for a specified time. The particle size distribution is then determined by weighing the residues on the individual test sieves.

The particle size distribution can also be determined by laser diffractometry, in particular according to ISO 13320:2009. In determining the particle size distribution of a material by laser diffractometry, the material to be tested may be suspended in a liquid medium, for example in ethanol, and the suspension may be exposed to ultrasonic treatment, for example for 120 seconds, followed by a pause, for example 120 seconds. The suspension can also be stirred, for example at 70 rpm. The particle size distribution can then be determined by plotting the measurement results, in particular the cumulative sum of the mass percentages of the measured particle sizes against the measured particle sizes. The d50 value can then be determined on the basis of the particle size distribution. For the determination of the particle size distribution and/or the d50 value of a material by laser diffractometry, for example, a particle size analyzer Helos available from the company Sympatec can be used with additional Sucell dispersion equipment.

In principle, many different materials can be used for the conductive material.

However, it has been found to be advantageous if the conductive material has a melting point which is sufficiently high that the conductive material remains completely in the solid state in the method according to the invention.

Consequently, the conductive material should have a melting point which is above the temperature to which the conductive material is exposed in the method according to the invention. According to a preferred embodiment of the method according to the invention, the conductive has a melting point of at least 500° C., preferably of at least 900° C., preferably of at least 1000° C., more preferably of at least 1100° C., even morepreferably of at least 1200° C. or most preferably of at least 1300° C. Such a melting point ensures that the conductive material remains completely in the solid state in the course of the method and that the conductive material does not melt.

In the method according to the invention, conductive material is excited by an electromagnetic field, as a result of which the conductive material heats up and gives off heat to the mineral bulk material to be thermally treated. It is particularly suitable for this purpose if the conductive material has an electrical conductivity of at least 1.0 10⁵ S/m, in particular of at least 1.0·10⁶ S/m, at a temperature of 25° C. It has been found that the heat transfer is particularly cost-effective, energy-efficient, and material-efficient if the conductive material has such an electrical conductivity. In this case, the energy transfer from the electromagnetic field to the mineral bulk material to be thermally treated is particularly successful.

In addition or independently thereof, the conductive material preferably has a specific heat capacity of 0.2 to 0.8 kJ/(kg·K), preferably from 0.3 to 0.7 kJ/(kg·K) or particularly preferably from 0.4 to 0.6 kJ/(kg·K). If the conductive material has such a specific heat capacity, the energy transfer in the method according to the invention for the thermal treatment of the mineral bulk material is particularly efficient.

In principle, the conductive material used in the method according to the invention can comprise any type of conductive material. However, conductive material which comprises at least one metal from the group consisting of iron, copper, tungsten, nickel, and cobalt is particularly suitable. The conductive material can preferably comprise a plurality of the metals mentioned, for example in the form of an alloy or in the form of a mixture of the pure substances. Alternatively, the material can also comprise only one of the metals mentioned. According to a further embodiment, the conductive material can consist of a metal from the group consisting of iron, copper, tungsten, nickel, and cobalt. Metals of the type mentioned are ideally suited for excitation by the electromagnetic field and are well suited for heat transfer. In addition, metals of the type mentioned are characterized by good thermal shock resistance and thermal stability.

The excitation of the conductive material with the electromagnetic field is particularly successful when the conductive material has ferromagnetic properties, such as cast iron, steel and/or other alloys or composite materials with ferromagnetic properties. Conductive material containing iron or made of iron has a high melting point and a high level of robustness. It can also be easily reused and cleaned and has a long shelf life even after repeated use. All common cast iron and steel grades known to a person skilled in the art, as well as ferromagnetic alloys and composite materials, are suitable as conductive material or as constituent of the conductive material for the method according to the invention, as long as they have magnetic properties.

In principle, the conductive material used in the method according to the invention can take on very different forms. However, it has been found to be advantageous for transporting and mixing with the mineral bulk material if the conductive material is substantially spherical. In this case, “substantially spherical” means that the conductive material has a spherical basic structure, which, however, can have certain irregularities.

The ratio of mineral bulk material to conductive material can vary over a wide range. The amount of mineral bulk material in the method step a. is advantageously at least 10 wt. %, preferably at least 20 wt. %, more preferably at least 30 wt. % or even more preferably at least 40 wt. %, based on the total amount of mineral bulk material and conductive material. According to a further preferred embodiment of the method according to the invention, the amount of mineral bulk material in method step a. is at least 50 wt. %, more preferably at least 60 wt. %, even more preferably at least 70 wt. %, more preferably at least 80 wt. % or most preferably at least 90 wt. %, based on the total amount of mineral bulk material and conductive material. If such an amount of mineral bulk material, based on the total amount of mineral bulk material and conductive material, is used in the method according to the invention, a cost-effective method implementation can be achieved in which also a particularly large material conversion of mineral bulk material can be achieved.

Regardless of the minimum amount of mineral bulk material, based on the total amount of mineral bulk material and conductive material, the amount of mineral bulk material in method step a. is, according to a preferred embodiment of the method according to the invention, a maximum of 90 wt. %, preferably a maximum of 80 wt. %, preferably a maximum of 70 wt. %, particularly preferably a maximum of 60 wt. %, based on the total amount of mineral bulk material and conductive material. In the case of the maximum quantities of mineral bulk material mentioned, the heat transfer from the conductive material to the mineral bulk material succeeds particularly well and the mineral bulk material is thermally treated uniformly in a short time.

According to a particularly preferred embodiment of the method according to the invention, the amount of mineral bulk material in method step a. is from 10 to 99 wt. %, preferably from 20 to 97 wt. %, preferably from 30 to 95 wt. %, more preferably from 40 to 93 wt. %, more preferably from 50 to 92 wt. %, particularly preferably from 60 to 90 wt. %, or particularly preferably from 70 to 85 wt. %, in each case based on the total amount of mineral bulk material and conductive material. Using such a ratio of mineral bulk material and conductive material, a high material conversion with good heat transfer is possible.

In principle, very different types of kiln are suitable for the method according to the invention. However, it is necessary that an electromagnetic field can be generated in the kiln. For the industrial, thermal treatment of mineral raw materials, it has been found to be particularly advantageous if the kiln is selected from the group consisting of shaft kiln, crucible kiln, rotary kiln and fluidized bed kiln. The kiln in the method according to the invention is particularly advantageously a shaft kiln.

It is advantageous if the kiln has a wall thickness through which sufficient electromagnetic radiation from a device mounted outside the kiln can penetrate into the kiln. For this purpose, it is advantageous if the kiln has a wall thickness of a maximum of 50 cm, preferably a maximum of 40 cm.

Using the method according to the invention, particularly high material throughputs can be achieved with efficient heat transfer at the same time if the kiln has an average inner diameter of 0.1 to 5 m, preferably 0.2 to 2 m, more preferably 0.3 to 1.5 m. In the case of a kiln with this average inner diameter, a particularly uniform electromagnetic field can also be generated throughout the kiln.

In this case, the average inner diameter means the mean value of the inner diameter along the heating zone of the kiln. If, for example, the diameter of the kiln is not uniform over the entire length or height of the heating zone of the kiln, the average inner diameter is determined by determining the mean value of the different diameters along the length or height of the heating zone of the kiln. The heating zone of the kiln is the area of the kiln in which conductive material passing through the electromagnetic field can be excited and heated. For example, if the kiln has an inner diameter of 1 m over a length of 25% of the heating zone of the kiln, an inner diameter of 1.5 m over the length of 50% of the heating zone of the kiln and an inner diameter of 2 m over a length of 25% of the heating zone of the kiln, the average inner diameter within the meaning of the invention is (1 m·0.25)+(1.5 m·0.5)+(2 m·0.25)=1.5 m.

According to a preferred embodiment of the method according to the invention, the electromagnetic field inside the kiln is generated by a device for generating an electromagnetic field which is located outside the kiln interior. In this way, there are no potentially disruptive interactions between the conductive material and the device for generating the electromagnetic field. In addition, the device for generating the electromagnetic field can easily be combined with existing kiln systems in this case.

In this case, the device for generating an electromagnetic field is preferably a coil. Coils are particularly well suited to generating the electromagnetic field. In addition, they are easy to mount and can be adjusted flexibly.

A particularly efficient heat transfer is achieved if the coil mounted so as to generate the electromagnetic field is cooled in method step c. In this way, the electromagnetic field generated remains particularly stable. In this case, the coil is preferably cooled with water and/or air.

According to a preferred embodiment of the method according to the invention, the coil has at least 10, preferably at least 30 or particularly preferably at least 50 turns. If the coil used in the method according to the invention has at least such a number of turns, a magnetic field particularly suitable for the excitation of the conductive material in the kiln can be induced in the method according to the invention.

Conductive material excited by the electromagnetic field heats up itself and the surroundings thereof; in particular, it results in heating of the mineral bulk material in the direct surroundings of the conductive material. For the thermal treatment of the mineral bulk material, it has been found to be particularly advantageous that the mineral bulk material in method step d. is exposed to a temperature of from 800 to 1500° C., preferably from 850 to 1450° C. or particularly preferably from 900 to 1250° C. The thermal treatment is particularly efficient at this temperature. If, for example, a mineral bulk material containing calcium carbonate is used in the method according to the invention, the expulsion of carbon dioxide is particularly efficient in the preferred temperature ranges. In addition, it is ensured within the preferred temperature ranges that there is minimal sintering of the mineral bulk material and that the conductive material does not melt.

If the mineral bulk material in method step d. is exposed to a temperature of from 800 to 1500° C., preferably from 850 to 1450° C. or particularly preferably from 900 to 1250° C., it is particularly advantageous if the conductive material has a melting point which is above the temperature to which the mineral bulk material is exposed, in particular if it has a melting point which is at least 50° C., preferably at least 100° C., more preferably at least 200° C. or particularly preferably at least 300° C. above the temperature to which the mineral bulk material is exposed.

For the excitation of the conductive material in the method according to the invention, it has been found to be particularly advantageous if the electromagnetic field in method step c. has a frequency of from 50 Hz to 30 MHz, preferably from 0.1 MHz to 2 MHz.

If a gas arises during the thermal treatment of the mineral bulk material in the kiln, it has been found to be advantageous for gas that arises during the thermal treatment to be extracted from the kiln. Preferably, the gas produced during the thermal treatment is extracted from the kiln by means of a fan. In this way, the thermal treatment can be accelerated and the conversion increased due to the shift in the reaction equilibrium.

In this case, the extraction of the gas produced during the thermal treatment from the kiln is particularly advantageous if the gas comprises carbon dioxide. In this way, the thermal treatment can be accelerated. If, for example, a mineral raw material containing calcium carbonate is calcined using the method according to the invention, the calcination can be significantly accelerated by extracting the carbon dioxide released. In addition, the required method temperature can be reduced in this way, thereby saving energy.

If gas comprising carbon dioxide is extracted during the thermal treatment, then, according to a preferred embodiment of the method according to the invention, at least part of the carbon dioxide extracted from the kiln is taken away for further use and/or storage. The carbon dioxide produced in the course of the method according to the invention is particularly pure and can be used directly for further use and/or storage without further processing or purification. In this way, a particularly ecological procedure is achieved that has reduced carbon dioxide emissions. Carbondioxide extracted from the kiln can be used, for example, as cooling or heating gas.

According to a preferred embodiment of the method according to the invention, the method further comprises at least the steps of:
f. cooling the removed mineral bulk material and the conductive material, and
g. separating the conductive material from the thermally treated mineral bulk material.

The conductive material is preferably separated from the thermally treated mineral bulk material after the mineral bulk material and the conductive material have cooled down. Alternatively, it is also possible for the conductive material to be separated from the thermally treated mineral bulk material before the mineral bulk material and the conductive material have completely cooled. If the mineral bulk material and the conductive material are separated from one another and cooled, regardless of the sequence, the method according to the invention results in conductive material which can be used for different applications.

According to a particularly preferred embodiment of the method according to the invention, after method step g., the separated conductive material is placed back into the kiln. It has been found that the separated conductive material is outstandingly suitable for reuse, even over a large number of cycles, in the method according to the invention. In this way, the method is carried out in a particularly ecological, economical manner that is gentle on the material.

The separation of the conductive material from the thermally treated mineral bulk material can be implemented in very different ways. It has been found to be particularly advantageous if the conductive material is separated from the mineral bulk material by means of a magnetic separator, gravimetric sorting and/or optical sorting. Using this separation method, an optimal separation of mineral bulk material and conductive material is ensured. The use of a magnetic separator is particularly suitable for separating the conductive material from the mineral bulk material, since the conductive material adheres to the magnetic separator, while the mineral bulk material does not interact with the magnetic separator.

According to a preferred embodiment of the invention, mineral bulk material adhering to the conductive material is mechanically separated. This can take place before or after, in particular after, the previous separation of the conductive material from the mineral bulk material by means of a magnetic separator, gravimetric sorting and/or optical sorting. The separation of mineral bulk material adhering to the conductive material can also take place entirely independently of further separation steps. The mechanical separation ensures that no more traces of mineral bulk material adhere to the conductive material, so that the conductive material can be reused without any contamination.

Different mechanical separation methods can be used for this purpose. According to a particularly preferred embodiment, the mineral bulk material adhering to the conductive material is separated off by means of a ball mill or tube mill. These separation processes have proven to be particularly advantageous in order to completely free the conductive material from mineral bulk material.

The cooling of the mineral bulk material and the conductive material according to method step f. can be designed in very different ways. The removed mineral bulk material and the conductive material are preferably cooled on a static or mobile grate. In this way, an efficient procedure can be implemented. The cooling of the mineral bulk material and the conductive material can take place in this case through the ambient air. Alternatively, it can also be cooled with compressed air.

The present invention further relates to a kiln comprising a kiln interior, a kiln wall, and a device for generating an electromagnetic field, wherein the device for generating an electromagnetic field is mounted outside the kiln interior and wherein the kiln has a wall thickness of a maximum of 50 cm. A kiln having these features is extremely suitable for the method according to the invention.

What has been said in connection with the method according to the invention for the kiln applies equally to the kiln according to the invention.

What has been said in connection with the method according to the invention for the kiln wall also applies equally to the kiln wall of the kiln according to the invention.

What has been said in connection with the method according to the invention for the device for generating an electromagnetic field also applies equally to the device for generating an electromagnetic field of the kiln according to the invention.

According to a preferred embodiment of the kiln according to the invention, the kiln comprises a fan for extracting gases. The fan can be used to extract gas which can arise during the thermal treatment in the course of the method according to the invention from the kiln interior, so that the thermal treatment is accelerated.

The invention also relates to the use of an electromagnetically excited conductive material for the thermal treatment of a mineral raw material. It has surprisingly been found that mineral raw materials can be thermally treated in an efficient manner with an electromagnetically excited conductive material. It was surprising, in particular, that sufficient heat is generated by the electromagnetically excited conductive material to thermally treat mineral raw materials, for example to completely calcine limestone.

What has been said in connection with the method according to the invention for the mineral raw material and the mineral bulk material also applies equally to the mineral raw material and the mineral bulk material for the use according to the invention.

What has been said in connection with the method according to the invention for the conductive material applies equally to the conductive material of the use according to the invention.

According to a preferred embodiment of the use according to the invention, the electromagnetically excited conductive material is used for calcining limestone and/or dolomite. The electromagnetically excited conductive material is particularly suitable for calcining limestone and/or dolomite. The transfer of heat from the electromagnetically excited conductive material to mineral bulk material based on limestone and/or dolomite is particularly efficient.

The invention further relates to burnt lime and/or burnt dolomite which can be obtained from the method according to the invention, wherein the mineral bulk material in the method according to the invention is selected from limestone and/or dolomite. The burnt lime and/or burnt dolomite which can be obtained from the method according to the invention is characterized by a high degree of purity and a uniform texture. In addition, the burnt lime and/or burnt dolomite which can be obtained from the method according to the invention is not sintered.

The invention also relates to an apparatus for the thermal treatment of a mineral raw material, which comprises
a first metering installation containing a mineral bulk material,
a second metering installation containing a conductive material,
a supply system for the transport of the mineral bulk material and the conductive material,
a kiln according to the invention, which comprises a fan for extracting gases,
at least one exhaust pipe connected to the kiln and the fan by means of which the extracted gas can be taken away,
at least one inlet on the kiln by means of which the mineral bulk material and the conductive material can be conveyed into the kiln by the supply system,
at least one gas-tight outlet on the kiln for removing the thermally treated mineral bulk material and the conductive material,
a discharge system for taking away the thermally treated mineral bulk material and the conductive material,
a separation system for separating the thermally treated mineral bulk material from the conductive material and
a further conveyor system for the transport of the separated conductive material to the second metering installation.

Using the apparatus according to the invention, the thermal treatment of mineral raw materials can be implemented in a particularly energy- and material-saving manner. Through the separation system and the further conveyor system, cleaned conductive material can be reused. The fan and the exhaust pipe allow the gas produced in the method to be effectively removed, which results in an increase in the efficiency of the method.

According to a preferred embodiment of the apparatus according to the invention, theinlet is a substantially gas-tight inlet. In this way, the extraction of gas produced during the thermal treatment is achieved in the best possible way. When a “substantially gas-tight inlet” is mentioned in this case, an inlet is meant from which only small quantities of gas can enter or exit. The “substantially gas-tight inlet” can also be a closable inlet that is gas-tight only in the closed state, but allows the free movement of air or gas flows in the open state. Such a closable inlet can, for example, be opened flexibly for placing the mineral bulk material and the conductive material and then closed for the duration of the thermal treatment of the mineral bulk material.

According to an advantageous embodiment of the apparatus according to the invention, the supply system and/or the discharge system and/or the further conveyor system comprise(s) a transport system suitable for bulk materials.

The separation system preferably comprises a magnetic separator and/or a gravimetric sorting system and/or an optical sorting system. The apparatus advantageously comprises a mechanical unit which can mechanically separate mineral bulk material adhering to the conductive material. The mechanical unit particularly preferably comprises a ball mill or a tube mill.

What has been said in connection with the method according to the invention for the kiln and what has been said in connection with the kiln according to the invention applies equally to the kiln of the apparatus according to the invention.

What has been said in connection with the method according to the invention for the device for generating an electromagnetic field also applies equally to the device for generating an electromagnetic field of the apparatus according to the invention.

What has been said in connection with the method according to the invention for the conductive material applies equally to the conductive material with respect to the apparatus according to the invention.

What has been said in connection with the method according to the invention for the mineral bulk material applies equally to the mineral bulk material with respect to the apparatus according to the invention.

What has been said in connection with the method according to the invention for the magnetic separator, the gravimetric sorting system, the optical sorting system, and the mechanical unit applies equally to the magnetic separator, the gravimetric sorting system, the optical sorting system, and the mechanical unit of the apparatus according to the invention.

### BRIEF DESCRIPTION OF THE DRAWINGS

The invention is explained in more detail below with reference to a drawing depicting a single preferred embodiment.

FIG. 1 is a schematic representation of a possible apparatus according to the invention.

### DESCRIPTION OF THE INVENTION

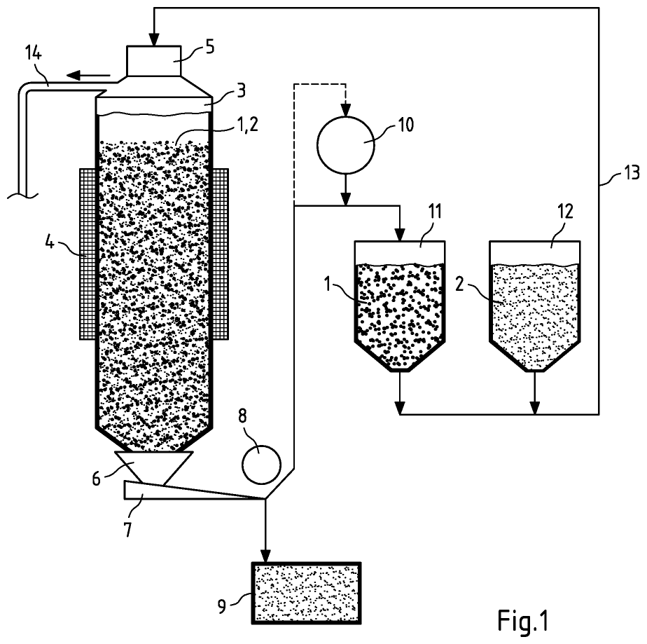

FIG. 1 shows a schematic representation of a possible apparatus according to the invention as it can also be used in the method according to the invention. Conductive material 1 and mineral bulk material 2 are placed into the interior of the kiln 3. The kiln 3 can be, for example, a shaft kiln, crucible kiln, rotary kiln or fluidized bed kiln. It is preferably a shaft kiln. The device for generating an electromagnetic field 4, which is located outside the kiln interior, generates an electromagnetic field. The device for generating an electromagnetic field 4 can for example be a coil. The conductive material 1 and the mineral bulk material 2 are conveyed into the interior of the kiln 3 through the inlet 5 on the kiln 3. The thermally treated mineral bulk material as a product of the method and the conductive material 1 are removed from the kiln 3 through the outlet 6 of the kiln 3. The discharge system 7 serves to take away the thermally treated mineral bulk material and the conductive material 1. The discharge system 7 can, for example, be a transport system suitable for bulk materials. The thermally treated mineral bulk material and the conductive material are separated via the separation system 8. The separation system 8 can be designed, for example, as a magnetic separator and/or gravimetric sorting system and/or optical sorting system. It is preferably a magnetic separator. The optionally provided cooler 9 serves to cool the thermally treated mineral bulk material obtained. The mechanical unit 10 can mechanically separate mineral bulk material adhering to the separated conductive material 1. The mechanical unit 10 can be designed, for example, as a ball mill or a tube mill. The separated conductive material 1 is then conveyed on to the second metering installation 11. The cleaned conductive material 1 can thus be reused. New mineral bulk material 2 is added from the first metering installation 12 and conveyed into the kiln 3 via the supply system 13. The fan 14 can be used to extract gas which may arise during the thermal treatment in the course of the method according to the invention from the kiln interior, so that the thermal treatment is accelerated.

### LIST OF REFERENCE SIGNS

1 Conductive material

2 Mineral bulk material

3 Kiln

4 Device for generating an electromagnetic field

5 Inlet

6 Outlet

7 Discharge system

8 Separation system

9 Cooler

10 Mechanical unit

11 Second metering installation

12 First metering installation

13 Supply system

14 Fan

1. A method for the thermal treatment of mineral raw materials, comprising at least the steps of:
a. providing a mineral bulk material and a conductive material,
b. placing the mineral bulk material and the conductive material into a kiln,
c. generating an electromagnetic field inside the kiln,
d. thermally treating the mineral bulk material in the kiln by means of electromagnetic excitation of the conductive material in the electromagnetic field, and
e. removing the thermally treated mineral bulk material and the conductive material from the kiln.

2. The method according to claim 1, wherein the mineral bulk material and the conductive material are mixed before being placed into the kiln.

3. The method according to claim 1, wherein the mineral bulk material comprises a hydroxide and/or a carbonate.

4. The method according to claim 1, wherein the mineral bulk material is selected from the group consisting of limestone, dolomite, magnesite, hydrated lime, carbonate ores and mixtures thereof.

5. The method according to claim 1, wherein the mineral bulk material has a bulk density of from 1.0 to 3.0 t/m3, in particular from 1.1 to 2.6 t/m3.

6. The method according to claim 1, wherein the has a melting point of at least 500° C. in particular at least 900° C. or at least 1000° C. or at least 1100° C. or at least 1200° C. or at least 1300° C.

7. The method according to claim 1, wherein the conductive material comprises at least one metal from the group consisting of iron, copper, tungsten, nickel, and cobalt, in particular iron.

8. The method according to claim 1, wherein the conductive material is substantially spherical.

9. The method according to claim 1, wherein that the conductive material has a mean particle size (d50) of from 1.0 to 70.0 mm, in particular from 2.0 to 50.0 mm.

10. The method according to claim 1, wherein the amount of mineral bulk material in method step a. is at least 10 wt. %. in particular at least 20 wt. % or at least 30 wt. % or at least 40 wt. %. based on the total amount of mineral bulk material and conductive material, and/or the amount of mineral bulk material in method step a. is a maximum of 90 wt. %. in particular a maximum of 80 wt. % or a maximum of 70 wt. % or a maximum of 60 wt. %, based on the total amount of mineral bulk material and conductive material.

11. The method according to claim 1, wherein the mineral bulk material in method step d. is exposed to a temperature of from 800 to 1500° C., in particular from 850 to 1450° C. or from 900 to 1250° C.

12. The method according to claim 11, wherein the conductive material has a melting point which is above the temperature to which the mineral bulk material in method step d. is exposed, in particular has a melting point which is at least 50° C. in particular at least 100° C. or at least 200° C. or at least 300° C. above the temperature to which the mineral bulk material is exposed.

13. The method according to claim 1, wherein the electromagnetic field in method step c. has a frequency of from 50 Hz to 30 MHz, in particular from 0.1 MHz to 2 MHz.

14. The method according to claim 1, wherein the gas which forms during the thermal treatment is extracted from the kiln, in particular is extracted from the kiln by means of a fan.

15. The method according to claim 14, wherein the gas comprises carbon dioxide.

16. The method according to claim 15, wherein at least part of the carbon dioxide extracted from the kiln is taken away for further use and/or storage.

17. The method according to claim 1, wherein the method comprises at least the steps of:
f. cooling the removed mineral bulk material and the conductive material, and
g. separating the conductive material from the thermally treated mineral bulk material.

18. The method according to claim 17, wherein, after method step g., the separated conductive material is placed back into the kiln.

19. A kiln comprising a kiln interior, a kiln wall, and a device for generating an electromagnetic field, wherein the device for generating an electromagnetic field is mounted outside the kiln interior and wherein the kiln has a wall thickness of a maximum of 50 cm.

20. The kiln according to claim 19, wherein the kiln comprises a fan for extracting gases.

21. The kiln according to either claim 19, wherein the kiln has an average inner diameter of 0.1 to 5 m, in particular 0.2 to 2 m, or 0.3 to 1.5 m.

22. A use of an electromagnetically excited conductive material for the thermal treatment of a mineral raw material.

23. The use according to claim 22, wherein the mineral raw material is a mineral bulk material and/or the electromagnetically excited conductive material.

24. The use according to either claim 22, wherein the electromagnetically excited conductive material is used for calcining limestone and/or dolomite.

25. The burnt lime and/or burnt dolomite which can be obtained from a method according to claim 1, wherein the mineral bulk material is selected from limestone and/or dolomite.

26. The apparatus for the thermal treatment of a mineral raw material, comprising
a first metering installation containing a mineral bulk material,
a second metering installation containing a conductive material,
a supply system for the transport of the mineral bulk material and the conductive material,
a kiln according to claim 20,
at least one exhaust pipe connected to the kiln and the fan by means of which the extracted gas can be taken away,
at least one inlet on the kiln by means of which the mineral bulk material and the conductive material can be conveyed into the kiln by the supply system,
at least one gas-tight outlet on the kiln for removing the thermally treated mineral bulk material and the conductive material,
a discharge system for taking away the thermally treated mineral bulk material and the conductive material,
a separation system for separating the thermally treated mineral bulk material from the conductive material.
a further conveyor system for the transport of the separated conductive material to the second metering installation.

27. The apparatus according to claim 26, wherein the inlet is a substantially gas-tight inlet.
